(19) United States
(12) Patent Application Publication
(10) Pub. No.: US 2007/0263222 A1
(43) Pub. Date: Nov. 15, 2007

(54) Monitoring Road Reflectance and Street Lighting

(76) Inventor: Roger John Loveless, Hamilton (NZ)

Correspondence Address: BLAKELY SOKOLOFF TAYLOR & ZAFMAN, 1279 OAKMEAD PARKWAY, SUNNYVALE, CA, 94085-4040, US

(21) Appl. No.: 10/554,470

(22) PCT Filed: Apr. 26, 2004
(86) PCT No.: PCT/NZ04/00080

§ 371 Date: Mar. 26, 2007

(30) Foreign Application Priority Data
Apr. 24, 2003 (NZ) 525523

(51) Int. Cl. G01N 21/55

(52) U.S. Cl. 356/445

(57) ABSTRACT

This invention relates to an apparatus for measuring and recording reflectance of a road surface compliance with luminance-specified lighting standards for roads, said apparatus including at least one road surface reflectance monitoring system capable of determining at least one spectral component and brightness of light reflected from the road surface, said system including at least one light emitter adapted to emit light toward the road surface, at least two non-coaxial light detectors adapted to detect light reflected from the road surface, to determine said spectral component, and at least one further light emitter adapted to emit light toward the road surface, at least one further light detector adapted to detect light reflected from the road surface, to determine said brightness, said apparatus further including at least one data recording system, and at least one output device adapted to receive data from the light emitter and the light detectors and provide at least one output signal to the said at least one data recording system regarding a level of received reflectance from the road surface.

### TECHNICAL FIELD

This invention relates to an improved measuring system.

In particular, this invention relates to an improved performance measuring system for vehicular traffic main highway lighting including motorways.

### BACKGROUND ART

Streetlights are designed to provide adequate levels of lighting to both pedestrians and vehicles. Street lighting in built up areas is designed to provide a safe and comfortable visual environment for pedestrian movement at night. Such lighting is provided at an adequate level both for convenience and for safety.

Other street lighting includes lighting installations for large intersections on highways and motorways, and general lighting of normal roadways. These installations are applicable to roads on which the visual requirements of motorists are dominant.

With the advent of such lighting, regular maintenance and monitoring become essential, with payment on contract agreements usually being performance based. Electrical contractors that install, maintain and repair the light systems may be required to provide set levels of performance as defined by the particular roading classification of each roadway. For vehicular traffic, (being category V-type lighting, AS/NZS 1158 standard in Australia and New Zealand), roading managers must also consider the properties of the road surface which influence the luminance performance of the street lighting installation. One property of interest is the light reflectance of the roading surface.

Current performance based contracts recognise the current road lighting situation and may include measures to drive:
Maintenance of the existing lighting inventory to retain such inventory in good working condition throughout its economic life.
Maintenance of the condition of the physical lighting asset in a safe condition.
Upgrade of the present inventory to meet the current national standards.
Upgrade of the present inventory to provide the required level of service (LOS) in an energy efficient manner.

Other measures may be included in a performance-based contract to cover specific issues such as the provision of flag lights at intersections, responses to service requests and emergency responses.

The aim of such current performance based contracts is to ensure the most efficient maintenance of the lighting system along with the most cost effective means.

The existing methodology for analysis of street lighting designs for existing streets is to manually collect the relevant data including:
Road width—the width of the actual carriageway sections excluding parking lanes,
Entire road width—includes parking lanes and central reserves,
Entire road-reserve width—the area between the opposing section boundaries including pathways and grassed areas,
The traffic count, average daily traffic,
Any additional data such as proximity to shops or other civil amenities that may affect the classification of the road or adjacent pathway, and
Displacement, offset, mounting height, angle of tilt, angle from kerb line and type of streetlights installed along the road.

Appropriate road classifications to the appropriate national standard are then nominated by the local authority, taking into consideration future developments for the area and road type. There are two basic classification series, being for pedestrian focused designs, and for vehicle driver focused main road designs. These are designated as categories P and V to the Australian and New Zealand joint AS/NZS 1158 standard respectively.

The road details are then entered into various software packages that compute whether the lighting as installed is compliant to the lighting Standards. However, this cannot take into consideration any external factors such as maintenance issues including the cleanliness of the lamp unit, degradation of lamp lumen output and whether the lamp diffuser has been affected by ultraviolet degradation or foliage obstructions that may reduce the available lighting level.

The existing lighting level can also be measured using a hand held light meter in order to determine whether the lighting level is acceptable, although this does not measure the reflected light from the road surface, which is used to determine compliance for main road classifications.

Such a hand held system is extremely slow, will usually require a full traffic management plan and may require the closure of the carriageway to ensure the safety of the operators.

Such a measurement is however essential to both ensure that contractors are correctly maintaining any agreed street lighting levels of service, and to ensure maintenance and repair is, and has been, carried out as required.

Presently pedestrian focused designs, and to some extent main road designs, can be checked using illuminance-measuring equipment, which allows the automatic collection of illuminance readings along a known reference line above a road. A light meter is located on the roof of a survey vehicle at a known height and the data is recorded on a laptop computer in the vehicle. This type of illuminance reading collection is acceptable for pedestrian focused designs and also indicates where any problem areas are on a main highway. Carriageway lighting component condition rating, risk rating and profile measurements also require daylight inspection of the installations, and condition of such is assessed against reference photographs of the components agreed as typical of that condition.

With lighting level measurements, the data can be collected automatically from a moving survey vehicle by using specialist sensors and equipment that can be easily installed on that vehicle. The current equipment design allows data collection at normal road speeds, which has the following benefits:
The surveyor can utilise any light vehicle for the survey. The only requirement is the addition of a transducer to allow a displacement pulse to be recorded. The transducer used is an industry standard component.
No warning beacons or safety signage is required, as would be essential with a slow moving survey vehicle.
The equipment used allows the speed to fluctuate during any test depending on road conditions. An even or dedicated speed is not required.

Although the survey equipment has been designed for simple operation and automatic data collection, two operatives are required to carry out the survey, allowing the driver to concentrate purely on safe driving. On two lane roads the driver is required to position the vehicle to ensure the recording light sensor is located approximately one meter from the centreline of the carriageway. The operator or measuring system needs to identify the start location and start the data acquisition at the predetermined start point on the road. All data collection and recording is performed automatically until the end of the run, leaving the operator free to make notes of factors that could affect the graphical output.

Main road designs however require consideration of surface reflecting properties that affect luminance of the lit road surface.

At present, only an indication of compliance to the Standards on main roads, based on assumed reflective properties of the surface, can be provided. The reflective properties are not currently measured and may prove to be very different than those assumed.

It would be an advantage to be able to collect all the relevant information required to assess illuminance and luminance levels on main roads.

Furthermore, it would be an advantage to be able to collect such relevant data at speed, therefore negating the need to either slow or stop traffic in the areas to be measured.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

It is an object of the present invention to address the foregoing problems or at least to provide the public with a useful choice.

Further aspects and advantages of the present invention will become apparent from the ensuing description which is given by way of example only.

### DISCLOSURE OF INVENTION

According to one aspect of the present invention there is provided an apparatus for measuring and recording reflectance of a prepared surface, said apparatus including
at least one data recording system,
at least one light emitter adapted to emit light toward the prepared surface,
at least one light detector adapted to detect light reflected from the prepared surface, and
at least one output device adapted to receive data from the light emitter and the light detector and provide at least one output signal to the said at least one data recording system regarding the level of received luminance from the prepared surface.

According to another aspect of the present invention there is provided an apparatus as claimed above, wherein said at least one light detector is adapted to only detect light emitted from the said at least one light emitter.

In some embodiments the prepared surface may be roading, pedestrian walkways or streets, sporting grounds or recreational areas, however these are listed by way of example only and should not be seen to be limiting in any way.

In preferred embodiments the prepared surface may be roading suitable for vehicles.

In some embodiments the light emitters and light detectors may be used to send and receive light to and from a prepared surface such as a roading surface.

In further embodiments the light emitter and detector may be considered as a set, with at least one set being required to provide valid emission and detection for roading surface reflectance lighting assessment and recordal, however this is listed by way of example only and should not be seen to be limiting in any way.

In other embodiments however the there may be multiple emitters and one detector or vice versa, depending on the requirements of the system.

In preferred embodiments, the light emitter/detector sets are automotive grade light sources and photosensitive devices respectively.

In some embodiments the data recording system or systems should be seen to include programmable logic devices, data-loggers, plotters, printers or the like, but these are listed by way of example only.

In preferred embodiments the data recording system may be a programmable logic device such as a laptop computer.

It should be further appreciated that in order to accurately detect light reflected from a prepared surface, extraneous light, or light not emitted from designated light emitter/s, must be removed or not allowed to affect any final reading. As such, in preferred embodiments, the light emitted from the designated light emitter or emitters could be shielded from external light sources. The light detector or detectors would then only register the intentionally emitted light, therefore providing an accurate reading of the road surface reflectance that can be used to determine the overall luminance of the roading when it reflects normal light sources such as street lighting, ambient light or other light sources such as sign lighting or the like.

The ability to accurately measure light reflected from a prepared surface such as a road by means of apparatus that can be used alone . is a distinct advantage over the present technology. Presently assumptions are made regarding the reflectance of prepared surfaces, or apparatuses are used which are slow to provide information. The present invention provides an apparatus that is shielded from extraneous light, providing an accurate reading using a dedicated light source.

According to another aspect of the present invention there is provided an apparatus as claimed above adapted for use in a vehicle moving over a prepared surface.

The ability to use the above claimed apparatus with a vehicle provides a further advantage to a user in that information regarding the reflectance of a prepared surface such as a road can be gathered quickly and at the same time that other information could be being gathered. This allows for the combination of greater accuracy of measurements and increased speed for gathering a data sample set regarding roading reflectance and the like.

According to another aspect of the present invention there is provided an apparatus for measuring and recording main lighting

said apparatus including

a) at least one data recording system,
b) at least one light emitter adapted to emit light toward the prepared surface,
c) at least one light detector adapted to detect light reflected from the prepared surface,
d) at least one light detector adapted to detect light received directly from the installed light sources.

As known to those skilled in the art, there is little physical difference between the actual luminaries or lighting types used on either pedestrian focused or vehicle driver focused main road classifications.

The requirements for main road lighting are not only more stringent in terms of the minimum and maximum lighting levels and uniformity of light, but also, bring a requirement to measure the luminance of the road surface. This luminance factor for the road is dependant on the physical surface of the road and can vary depending on the wear to that particular surface and the prevailing weather conditions that change the degree of dampness of the surface. The relevant performance parameters for main road classification roading are:
Average carriageway luminance,
Overall luminance uniformity,
Longitudinal luminance uniformity,
Threshold increment, and the
Surround (verge) illuminance ratio

Adherence to the appropriate levels for each of these parameters ensures adequate main road lighting levels are maintained at all times.

It should be further appreciated that in order to accurately measure each of these parameters, extraneous light, or light not emitted from a designated light emitter or emitters, must be removed or not allowed to affect any reading as discussed previously.

The light detector or detectors would then only register the specifically emitted light, therefore providing an accurate reading of the road surface reflectance that can be used to determine the luminance of the roading for each of the relevant luminance based performance parameters. This is a distinct advantage over the current prior art, where assumptions are made that influence the relevant performance parameters, rather than actual independent measurements being taken.

In preferred embodiments the light emitters and light detectors can be shielded from other light sources such as street lighting, ambient lighting, sign lighting or the like by an enclosure that could surround the emitter and detector array or arrays.

Such an enclosure could then be further edged by a soft resilient material that could come into contact with a prepared surface, such as a road. Such a material would have high resistance to wear over time, providing a seal sufficient to keep extraneous light to a minimum, or to such a level that it would not sufficiently affect the readings being taken.

In preferred embodiments a soft resilient material may be nylon brush bristles.

In further embodiments the array and enclosure could be positioned close to the road where the reflectance measurement was being taken and accordingly, only light that was directed at the prepared surface would be reflected back to the detector or detectors, although this example is only intended to illustrate one way of shielding the emitter/detector array, other means of shielding could include the use of light of predetermined wavelength where the reduction in detection of emitted light would equal the amount of light deflected by the prepared surface and therefore not reflected back.

The term ‘lighting equipment’ should be understood to mean equipment intended to discharge or emit light, such as street lights, lamps, halogen lights, sodium discharge lamps, illuminated signs, but not limited to these.

In preferred embodiments this lighting equipment may include road lights or lanterns as currently in use today, and those being well known to those skilled in the art.

It should be appreciated that the detectors and emitters relating to both reflected light and transmitted light provide output that can be sensed or measured and recorded by sensing devices.

In some embodiments sensing device or devices which respond to illumination received from light transmittance equipment are well known in the art and include sensors such as photoelectric cells, photosensitive devices, lux sensors, although these are listed by way of example only and should not be seen to be limiting in any way.

In preferred embodiments the sensing device or devices may be photosensitive devices.

In some embodiments the output means for providing output signals related to the level of received illumination from the light transmittance equipment include lux meters or other types of output devices known to those skilled in the art.

In preferred embodiments the output means may be photosensitive devices.

In preferred embodiments where the data recordal system could be a laptop computer, such a computer could be configured to receive information from the light transmittance equipment sensors, the light transmittance detector equipment and any other information as seen to be relevant by a user, including location details, speed and acceleration details, but these are listed by way of example only and should not be seen to be limiting in any way.

According to another aspect of the present invention there is provided an apparatus for recording reflectance of a prepared surface adapted for use with a vehicle

said apparatus including

a) at least one logging device adapted to log the position of the vehicle in the course of travel along a route,
b) at least one light emitter adapted to emit light toward the prepared surface,
c) at least one light detector adapted to detect light reflected from the prepared surface,
d) at least one output means which provides output signals related to the prepared surface reflectance, and
   at least one recording device adapted to record the at least one output signal and a logging device output signal to said at least one recording device being adapted to record the output of the prepared surface reflectance in combination with the position of said vehicle on said route.

In preferred embodiments the vehicle is able to travel at the usual speed designated for each road classification along the desired route. Accordingly, the apparatus is able to measure and record readings at speeds of up to 160 kilometres per hour, that speed being the speed allowable on some highways and Autobahns in various countries around the world. This is an advantage over the present art in that in general terms as no special provisions such as road blocks, speed restrictions or the like need to be put into place when the lighting levels are being measured.

In further embodiments the position of the vehicle along the route can be logged, either by use of a global positioning satellite (GPS) device, or other position logging means.

Additionally, the speed and height of the vehicle mounted sensing equipment from the road surface may also be logged. This information in conjunction with the position of the vehicle overall may provide an accurate reading of where the vehicle is at any time, and hence, provide a further indication of where readings are recorded. Such an outcome provides an easy reproducibility to any data collected and means that such data can be on-sold if desired to interested parties, or overlaid on a graphical information system (GIS) to provide an accurate indication of where faults may lie, or what regions are being well maintained.

According to another aspect of the present invention there is provided an apparatus for recording the condition of main road lighting adapted for use with a vehicle

said apparatus including

a) means for logging the position of the vehicle in the course of travel along a route
b) at least one light emitter adapted to emit light toward the prepared surface
c) at least one light detector adapted to detect light reflected from the prepared surface,
d) at least one light detector which responds to illumination received directly from the installed light sources,
e) at least one output means for providing output signals related to the level of received illumination from the light transmittance equipment
f) at least one output means which provides output signals related to the road surface reflectance that can be used to determine the level of received luminance from a road surface, and
g) recording means for recording the output signals in correlation with the logging means to provide a recording of the output of the lighting equipment and the road surface reflectance with the position of said vehicle on said route.

According to another aspect of the present invention there is provided a method of monitoring main road lighting including the steps of:
a) driving a vehicle along a route while street lighting is operative
b) recording the illumination provided by the street lighting,
c) recording the road surface reflectance that can be used to determine the luminance properties of the route surface, and
d) recording the position of the vehicle in the course of the vehicle's travel along said route.

In further preferred embodiments in should be appreciated that apparatus configured for measuring and recording main road lighting can also be further adapted to measure and record key parameters to determine compliance with luminance specified light standards for main roads.

Therefore, rather than measuring main road lighting directly, key parameters can be assessed to determine compliance with luminance specified lighting standards for main roads.

According to another aspect of the present invention there is provided an apparatus for measuring luminance and illuminance sources from luminaries and in association with a prepared surface, said apparatus including
a) at least one data recording system
b) at least one light emitter adapted to emit light towards the prepared surface for the purposes of determining the at least one spectral component of the reflected light,
c) at least two light detectors adapted to detect light reflected from the prepared surface
d) at least one separate surface lighting system for illuminating the prepared surface
e) a luminance measuring system adapted to determine the brightness of the prepared surface
f) an illuminance measuring system adapted to determine the light output of luminaries and
g) at least one output device adapted to receive and process data from the luminance measuring system, and the illuminance measuring system and the at least two detectors.

The term ‘key parameters’ in accordance with the present invention should be understood to refer to parameters that can be measured and, in conjunction with other data recorded for an asset, be used to determine compliance with luminance specified light standards for roads.

It should be appreciated that reference to roads should be assumed to encompass various road ways and the like as discussed previously, however in preferred embodiments the key parameters will usually relate to parameters measured for main roads.

The key parameters for the present invention, in preferred embodiments, relate to components of reflectivity, which are split up into at least two components.

In preferred embodiments the reflectivity is split up into two components, one relating to how spectral the surface of the road is, and therefore a spectral coefficient is provided, and the other relating to its overall brightness or luminance coefficient.

It should be appreciated that the spectral coefficient may be calculated by projecting a light at a surface and recording the reflected components in two or more directions.

The spectral component of the luminance measurement may be made up by projecting a separate light source on to a surface and then measuring luminance in at least two directions to cover different angles. The individual measurements may be made with a suitable photosensitive device that collects light over a limited solid angle, said angle determined by a suitably sized and constructed tubular sight. Tubular sights are well known to those skilled in the art.

In preferred embodiments the spectral coefficient, hereinafter referred to as S₁, may be made up of two components, being γ and C, wherein γ and C relate to the vertical and azimuth angles respectively, as defined in the CIE publication No. 27 for street lighting and as known to those skilled in the art.

Light may be projected onto the surface at an incident angle of γ, and the two or more sensors configured to record the reflected components in two or more directions then detect that light, and a ratio is taken between the light received at each sensor.

It should also be appreciated that the apparatus may include multiple sensors so that multiple reflected components can be recorded. Those multiple readings could then be used to determine the ratio several times over and an average of the ratio could then be taken, although this should not be seen to be limiting and is listed by way of example only.

The ratio provided by at least two sensors provides an indication of S₁. Once S₁ is determined, it can then be used to select the most appropriate reflectivity table from a predefined set taken from the appropriate standards. In some cases, those appropriate standards may include the AS/NZS standard four tables, as known to one skilled in the art.

It should be appreciated that the separate surface lighting system may be used to illuminate the prepared surface so that the overall brightness or luminance coefficient can be determined.

The term ‘brightness’ is well known to one skilled in the art and in general terms refers to the degree of light absorption or light absorption properties of a particular surface, in this case, a prepared surface, although the description of these general terms should not be seen to be limiting in any way.

It should further be appreciated that the luminance measuring system used to determine the brightness of a prepared surface would be well known to one skilled in the art, as would be the illuminance measuring system for determining the light output of the luminaries.

As detailed above, it should be appreciated that the apparatus for measuring and recording main road light can be used to also measure and record key parameters, and in preferred embodiments, it is the key parameters that are used rather than the recordal of the main road light directly. As such, reference throughout the specification to main road lighting, and apparatus for measuring such should be recognised to also include apparatus and method of use of such for measuring and recording key parameters to determine compliance with luminance specified lighting standards or the like.

It should also be appreciated that luminance specified lighting standards for main roads are standards that may vary according to jurisdictions, preferences of regions, or in accordance with national required levels and should therefore not be seen to be limiting in any way.

According to another aspect of the present invention there is provided an apparatus for measuring luminance and illuminance sourced from luminaries and in association with a prepared surface, said apparatus including
a) at least one logging device adapted to log the position of the vehicle in the course of travel along a route,
b) at least one data recording system
c) at least one light emitter adapted to emit light towards the prepared surface for the purposes of determining the spectral component of the reflected light,
d) at least two light detectors adapted to detect light reflected from the prepared surface
e) at least one separate surface lighting system for illuminating the prepared surface
f) a luminance measuring system adapted to determine the brightness of the prepared surface
g) an illuminance measuring system adapted to determine the light output of luminaries,
h) at least one transmitting device adapted to provide an output signal relating to the level of received illumination from light transmittance equipment, and
   wherein said at least one output device is also adapted to receive and process data from the luminance measuring system, the illuminance measuring system and the at least two light detectors in combination with the logging device output signal and the transmitting device.

According to another aspect of the present invention there is provided a computer software package for recording and analysing data obtained from apparatus as claimed above,

wherein the software records the data provided from the light sensors at sufficient speed to allow a vehicle to travel at normal route allowable speeds.

It is an advantage of the present invention that main road lighting measurements may be measured, recorded and collated at speed without the need for major disruption to traffic patterns.

Furthermore, it is an advantage of the present invention that such information collected may be used to determine the adherence of contractors and the like to performance agreements. Such information could also potentially be used to determine what areas have the greatest lighting problems, potentially providing an indication as to power supply problems or the like.

### BRIEF DESCRIPTION OF DRAWINGS

Further aspects of the present invention will become apparent from the following description which is given by way of example only and with reference to the accompanying drawings in which:

FIG. 1 Shows a diagram of a preferred embodiment of the present invention;

FIG. 2 Shows a diagram of another preferred embodiment of the present invention;

FIG. 3 shows a graph representing a well lit/maintained road, and

FIG. 4 shows a graph representing a badly lit/maintained road.

### BEST MODES FOR CARRYING OUT THE INVENTION

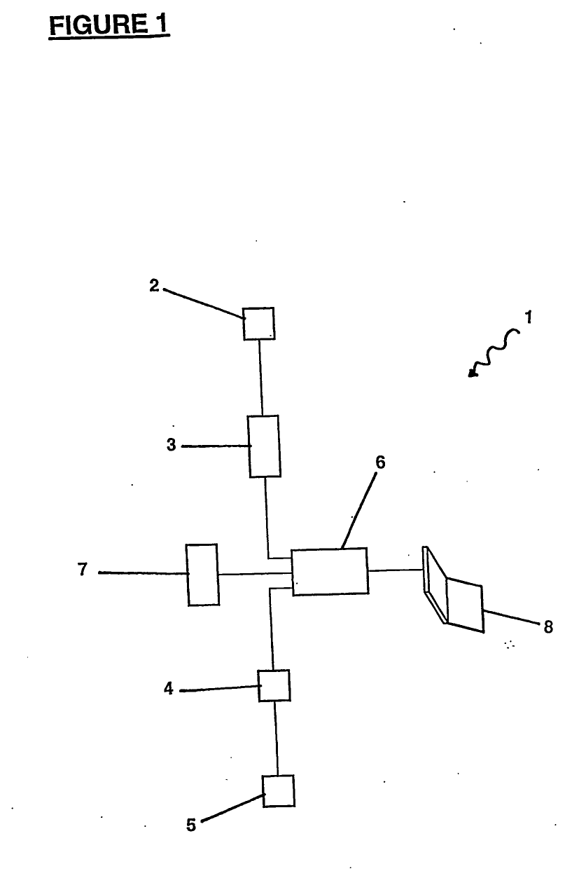

With reference to FIG. 1 there is illustrated a preferred embodiment of the present invention, being a block diagram showing the preferred components of an apparatus for measuring and recording main road lighting, generally indicated by arrow 1.

The means for logging the position of a vehicle, in this embodiment represented by a transducer (2), driven by the speedometer drive cable, provides a pulsed output to a displacement meter (3), which is positioned in the car (not shown), and which provides an indication of distance travelled from a set start point.

The output means which provides output signals related to the level of received illumination from the installed light sources, in this embodiment represented by a lux meter (4), positioned in the car, measures light levels as provided by the photosensitive device (5) positioned on the roof of the car, the photosensitive device being the light detector adapted to detect light from the installed light sources.

The transducer (2), displacement meter (3), lux meter (4) and photosensitive device (5) are all connected to a data sampler (6) positioned in the car.

Also connected to a recording means, in this embodiment represented by a data sampler (6) is the prepared surface reflectance measurement system (7).

The data sample is connected to a programmable logic device, in this embodiment being a laptop computer (8).

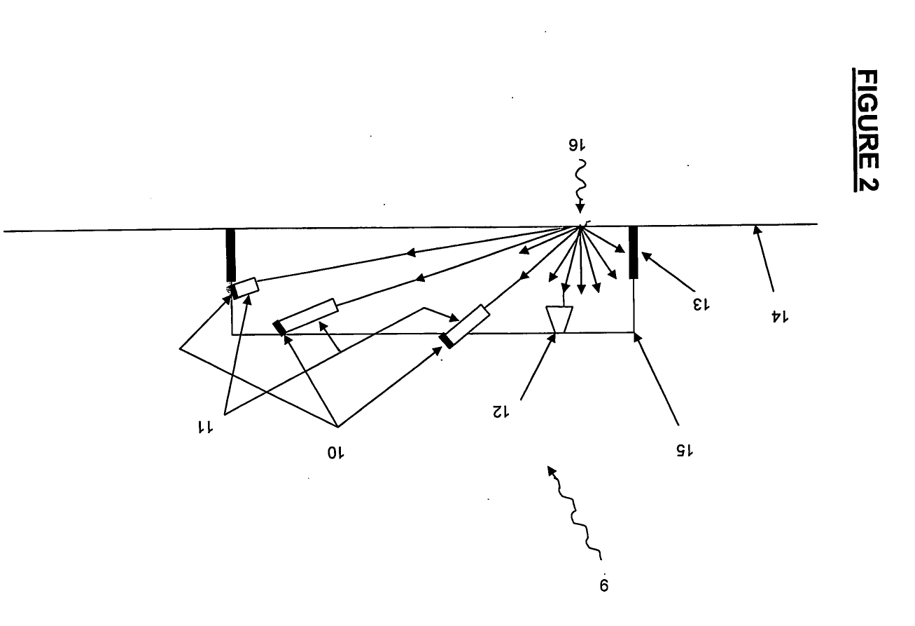

With reference to FIG. 2 there is illustrated another preferred embodiment of the present invention, being the reflectance measurement system generally indicated by arrow 9.

The light detectors, in this embodiment are represented by multiple photosensitive devices (10) with tubular sights (11) directed towards the road surface (14) at a point where the measurement light source (12) hits the road surface (14). The light detectors (10) detect the reflected light from the measurement light source (12), being a preferred embodiment of a light emitter.

The photosensitive devices (10), tubular sights (11) and measurement light source (12) are enclosed in an equipment enclosure (15) which has a soft brush seal (13) that is positioned against a- road surface (14).

Light from the measurement light source (12) is reflected off the road surface (14), that reflectance generally indicated by arrow 16.

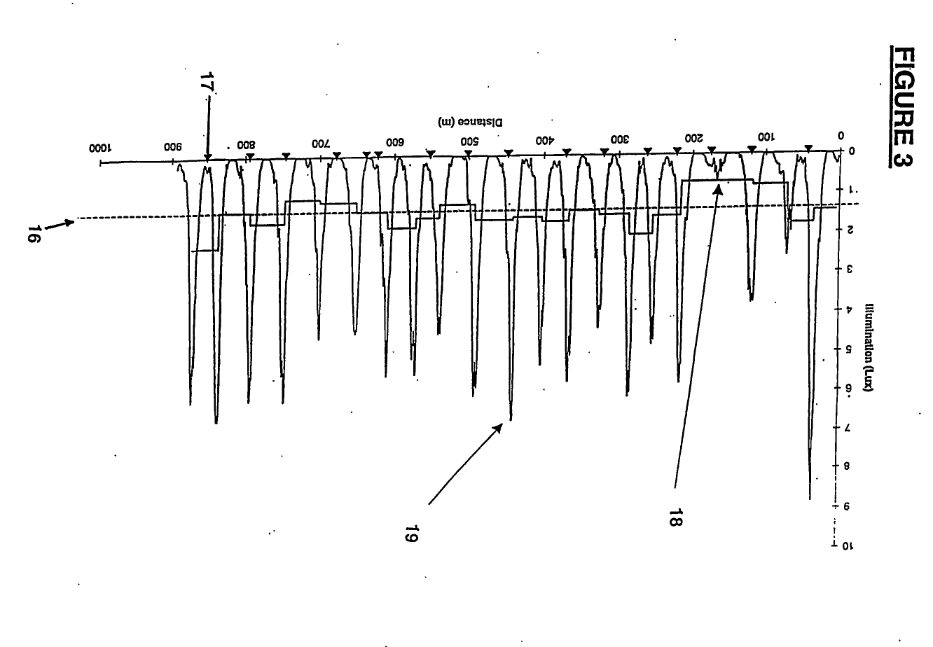

With reference to FIG. 3 there is illustrated a graph indicating a well maintained/lit road.

The dash line indicated by arrow 16 indicates the average lighting level in lux, being 1.39.

The triangles indicated by arrow 17 denote streetlights.

Arrow 18 indicates where light has been obscured by vegetation and indicates that maintenance is required.

Arrow 19 indicates where lighting is well maintained and it can be assumed from the graph that the light fittings are well positioned providing uniform illuminance.

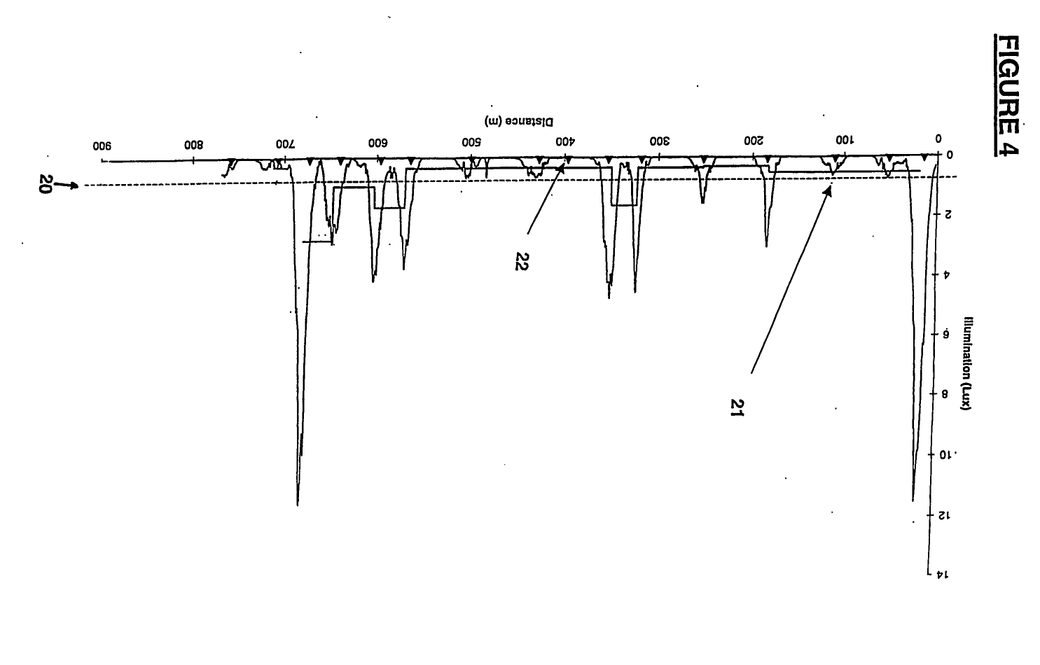

With reference to FIG. 4 there is illustrated a graph indicating a poorly maintained/lit road.

The dash line indicated by arrow 20 indicates the average lighting level in lux, being 0.78.

Arrow 21 indicates where light is poorly maintained and shows that there is insufficient illuminance delivered from the luminaire.

Arrow 22 indicates where lighting is not functioning at all.

A vehicle (not shown) containing the main road lighting measurement system (being all components of FIG. 1) begins measurements at a designated start position on a roadway.

At the start position all meters are started and the vehicle will then proceed to manoeuvre around a course, either pre-designated, or randomly.

The reflectance measurement system (9) could be positioned on the bottom of the vehicle or trailer attached to the vehicle and could be lowered into position when testing is initiated, so as to avoid excessive wear of the nylon brush (13).

The combination of the transducer (2) and the displacement meter (3) will provide an accurate definition of position of the vehicle and as such, the readings obtained from the photosensitive devices and reflectance system can be correlated with positions on a map.

The results obtained from the measurements can then be analysed to provide graphs or printouts such as illustrated by FIGS. 3 and 4. The readings obtained from the reflectance system can be used to give an indication of the reflectivity of the road surface, which can then be used to provide an indication of main road lighting performance.

From those graphs a level of maintenance, or need for maintenance can then be determined and contractors or councils notified accordingly.

Aspects of the present invention have been described by way of example only and it should be appreciated that modifications and additions may be made thereto without departing from the scope thereof as defined in the appended claims.

1. An apparatus for measuring and recording reflectance of a road surface compliance with luminance-specified lighting standards for roads, said apparatus including :
at least one road surface reflectance monitoring system capable of determining at least one spectral component and brightness of light reflected from the road surface, said system including;
at least one light emitter adapted to emit light toward the road surface,
at least two non-coaxial light detectors adapted to detect light reflected from the road surface,
to determine said spectral component and
at least one further light emitter adapted to emit light toward the road surface,
at least one further light detector adapted to detect light reflected from the road surface,
to determine said brightness;
said apparatus further including
at least one data recording system, and
at least one output device adapted to receive data from the light emitter and the light detectors and provide at least one output signal to the said at least one data recording system regarding a level of reflectance from the road surface.

2. An apparatus as claimed in claim 1, adapted for use with a vehicle
said apparatus also including:
at least one logging device adapted to log the position of the vehicle in the course of travel along a route, and
at least one recording device adapted to record the at least one output signal and a logging device output signal, said at least one recording device being adapted to record the output of the road surface reflectance in combination with the position of said vehicle on said route.

3. An apparatus as claimed in claim 1, said apparatus further including:
an illuminance measuring system adapted to measure incident light from external light sources including road lighting, and
wherein said output device is adapted to receive and process data from the illuminance measuring system.

4. An apparatus as claimed in claim 3 adapted for use with a vehicle said apparatus also including:
at least one light transmitting detector adapted to provide an output signal relating to a level of received illumination from external light sources including street lighting, and
wherein said at least one output device is also adapted to receive and process data from the logging device output signal and receive and process data from the transmitting device.

5. An apparatus as claimed in claim 1 wherein the light emitter is an automotive grade light source.

6. An apparatus as claimed in claim 1 wherein the light detector is a photosensitive device.

7. An apparatus as claimed in claim 1 wherein the reflectance monitoring system is shielded from external light sources.

8. An apparatus as claimed in claim 7 which includes a shield.

9. An apparatus as claimed in claim 8 wherein the shield includes a soft resilient material.

10. An apparatus as claimed in claim 7 wherein the shield is positioned in contact with the road surface.

11. An apparatus as claimed in claim 1 wherein the data recording system includes at least one programmable logic device.

12. An apparatus as claimed in claim 11 wherein the data recording system includes a computer.

13. An apparatus as claimed in claim 4 wherein the light transmitting detector includes at least one sensing device adapted to respond to illumination received from light transmittance equipment.

14. An apparatus as claimed in claim 13 wherein the sensing device includes at least one photosensitive device.

15. An apparatus as claimed in claim 13 wherein the sensing device includes at least one lux sensor.

16. An apparatus as claimed in claim 2 wherein the position of the vehicle is logged by global positioning satellite device.

17. An apparatus as claimed in claim 2 wherein the speed and height of the vehicle mounted sensing equipment from the road surface are recorded by a logging device.

18. A method of monitoring main road lighting using the apparatus claimed in claim 1, said method including the steps of:
a) driving a vehicle along a route while street lighting is operative,
b) recording the illumination provided by the street lighting,
c) recording the road surface reflectance that can be used to determine the luminance properties of the route surface, and
d) recording the position of the vehicle in the course of the vehicle's travel along said route.

19-32. (canceled)
